(19) United States
(12) Patent Application Publication
(10) Pub. No.: US 2007/0296284 A1
(43) Pub. Date: Dec. 27, 2007

(54) Magnetic Motor

(76) Inventor: Victor Diduck, Kelowna (CA)

Correspondence Address: VERMETTE & CO., SUITE 320 - 1177 WEST HASTINGS STREET, VANCOUVER, BC, V6E2K3, CA

(21) Appl. No.: 11/781,893

(22) Filed: Jul. 23, 2007

Related U.S. Application Data
(63) Continuation-in-part of application No. 11/163,273, filed on Oct. 12, 2005, now abandoned.

(51) Int. Cl. H02K 37/00

(52) U.S. Cl. 310/46

(57) ABSTRACT

A magnetic motor is disclosed and claimed having a magnetic drive assembly magnetically coupled to a magnetic slave assembly. The drive assembly has at least one drive magnetic. In one embodiment the drive magnet is mounted on a cowling. In another embodiment the drive magnet is mounted on a drive wheel. The slave assembly has at least one slave wheel mounted on a slave shaft. At least one slave magnetic is mounted on the slave wheel. In one embodiment slave magnets are mounted in grooves running diagonally across the face of the slave wheel. In another embodiment the slave magnets are mounted in notches cut into the slave wheel. The drive magnet is magnetically coupled to the slave magnet with their poles arranged in a like-faces-like orientation. The gap between the drive magnet and slave magnet can be adjusted in order to optimize the magnetic coupling therebetween. The slave wheel and its slave shaft are caused to rotate by the magnetic coupling between the drive magnet and the slave magnet. The slave shaft can be coupled to an output device such as an electric generator.

### REFERENCE TO RELATED APPLICATIONS

This application is a continuation-in-part of U.S. patent application Ser. No. 11/163,273, filed Oct. 12, 2005.

### FIELD OF THE INVENTION

The present invention relates to magnetic motors.

### BACKGROUND OF THE INVENTION

There have been a number of attempts to perfect magnetic motors; for instance, U.S. Pat. No. 4,151,431 issued to Howard Johnson. However, in most such devices no working models have been achieved. In order to make a permanent magnet motor operate it is necessary to accomplish a switching function equivalent to that accomplished in electric motors by brushes, commutators, alternating current, or other means. In permanent magnet motors magnetic leakage must be shielded so as to reduce energy lost as eddy energy. A proper combination of materials, geometry, and magnetic concentration is required in order to be able to construct a magnetic motor that can operate continuously.

### SUMMARY OF THE INVENTION

A magnetic motor is provided comprising a magnetic drive assembly magnetically coupled to a magnetic slave assembly. The magnetic slave assembly includes a rotatable slave shaft upon which is mounted at least one rotatable slave wheel. Upon the slave wheel is mounted at least one slave magnet. The magnetic drive assembly includes at least one drive magnet that is magnetically coupled to the slave magnet in a like-faces-like orientation. As a result of the magnetic coupling between the drive magnet and the slave magnet, magnetic forces produced between the coupled drive magnet and slave magnet drive the rotatable slave wheel, making it rotate and therefore causing the slave shaft to rotate. The slave shaft is coupled to an output device such as the armature of an electric generator.

The slave assembly is coupled to a frame. The slave wheels are fixed to the shaft so that the wheels rotate together. Each slave wheel has embedded in its surface a plurality of slave magnets set in indentations cut into the slave wheel. One pole of each slave magnet is exposed and facing outwards from the surface of the slave wheel, and the other magnet pole faces the slave wheel. Either the north pole or the south pole of the slave magnets may face outward, as long each magnet has the same pole facing outwards.

In one embodiment the indentations in the slave wheels for receiving the slave magnets form spaced apart, parallel grooves running from one side of the surface of the slave wheel to the other for receiving the slave magnets. The angle of each groove across the surface of the slave wheel is preferably about 35 degrees with respect to horizontal. The direction of orientation of the grooves of the other of the slave wheels is also about 35 degrees off of the horizontal, but in the opposite direction to that of the first wheel.

In another embodiment the indentations in the slave wheels for receiving the slave magnets are notches cut into the slave wheel at measured and equal intervals along the edges of the wheel, intervals of 45 degrees being preferred.

In a cowling embodiment of the invention, the magnetic drive assembly comprises a pair of non-magnetic cowlings surrounding and substantially enclosing each of the slave wheels. Each pair of cowlings forms a semi-circular surface having a diameter slightly larger than the diameter of its respective slave wheel. The concave curvature of the cowlings faces the slave wheels. Mounted on the convex surface of the cowlings are a plurality of permanent drive magnets. The drive magnets are mounted so that they present to the slave magnets the same pole as the slave magnets present to the drive magnets; i.e., like-faces-like—north-to-north or south-to-south. Neither the cowlings nor their drive magnets rotate.

In a drive wheel embodiment, the cowling pairs of the magnetic drive assembly are replaced by drive wheels mounted on a drive shaft that is oriented parallel to the slave shaft. The drive wheels are fixed to the drive shaft and both of the drive wheels and drive shaft rotate as a unit. Each drive wheel has mounted on it a plurality of currently permanent drive magnets. The preferred configuration of drive magnets is that four magnets are radially spaced apart at 90 degrees from each other on the edges of each drive wheel. The drive wheels and slave wheels are oriented so that their edges face each other, and hence, the drive magnets face the slave magnets. The pole of the drive magnets facing out of the drive wheels is the same as the pole of the slave magnets facing out of the slave wheels so that like-faces-like, and preferably north-to-north.

In the various embodiments, the gap between the drive magnets and the slave magnets is adjustable.

### BRIEF DESCRIPTION OF THE DRAWINGS

Further features and advantages of the invention will be apparent from the following detailed description taken in conjunction with the accompanying drawings, wherein:

FIG. 1 is a perspective view of the cowling embodiment of the magnetic motor with fly wheels attached.

FIG. 2 is partially disassembled perspective view of the cowling embodiment of the magnetic motor.

FIG. 3 is a diagram of the magnet placement on the cowling.

FIG. 4 is a schematic diagram of one slave wheel of the cowlings embodiment showing the position of the permanent magnets.

FIG. 5 is a schematic diagram of another slave wheel of the cowlings embodiment showing the position of the permanent magnets.

FIG. 6 is a perspective view of the drive wheel embodiment

FIG. 7 is a perspective view of the drive wheel and slave wheel of the drive wheel embodiment.

FIG. 8 is an end-view of a magnetic drive assembly employing drive wheels

FIG. 9 is a side-view of the magnetic drive assembly shown in FIG. 8.

### DETAILED DESCRIPTION OF THE INVENTION

### Cowling Embodiment

In the various embodiments of the invention there is generally provided a magnetic drive assembly and a magnetic slave assembly, with a magnetic field coupling the drive assembly to the slave assembly such that when the drive assembly rotates it causes the slave assembly to rotate. The coupling is entirely magnetic, with no chains, gears, pulleys, worm drives or other physical couplers are required.

Whilst the preferred embodiments discussed herein employ certain elements in combination, it is understood that the elements are generally interchangeable between embodiments and that the invention is not restricted to the number of elements described in a given embodiment.

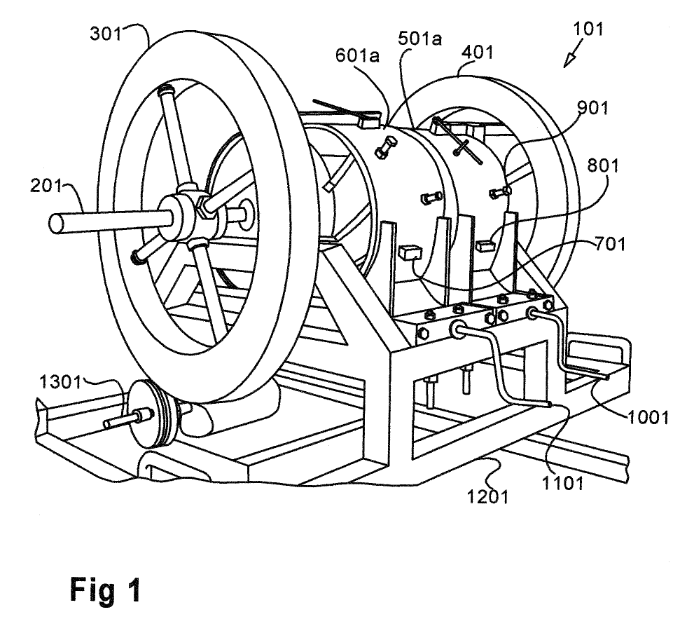

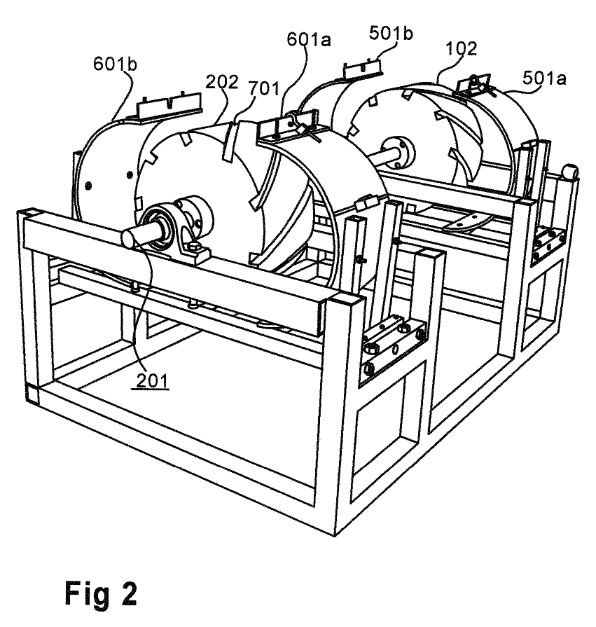

FIGS. 1 and 2 show a first embodiment of the invention, referred to herein as the “cowling embodiment” In this embodiment the magnetic slave assembly of the magnetic motor 101 comprises two solid non-magnetic slave wheels 102 and 202, most clearly seen in FIG. 2. The slave wheels are mounted on a slave shaft 201. FIG. 1 shows an embodiment in which optional fly-wheels 301, 401 are mounted on slave shaft 201. The fly-wheels may be conveniently mounted at or near the ends of the slave shaft. A device 1301 for generating electric current is provided that is directly coupled to the slave shaft, or indirectly coupled through a fly-wheel, as shown in FIG. 1, or though some other element of the magnetic slave assembly.

Except for elements noted herein, the invention is constructed of a non-magnetic material. Pheotic plastic or ceramic materials are currently preferred for the slave wheels and drive wheels, but a wide variety of non-magnetic materials is acceptable so long as the material does not create or exacerbate eddy currents. The diameter of the slave wheels in currently operating models is approximately 10 inches, and the width approximately 5 inches. The optimum dimensions of the slave wheels will be determined by the specific application of the invention.

As seen in FIG. 2, each slave wheel has a plurality of grooves running from one side to the other. One such groove is designated 701. The grooves in one wheel are oriented at an angle of about 35 degrees to the slave wheel edge, while the grooves of the second wheel are oriented at about 35 degrees to the opposite edge, as can be seen clearly in FIG. 2.

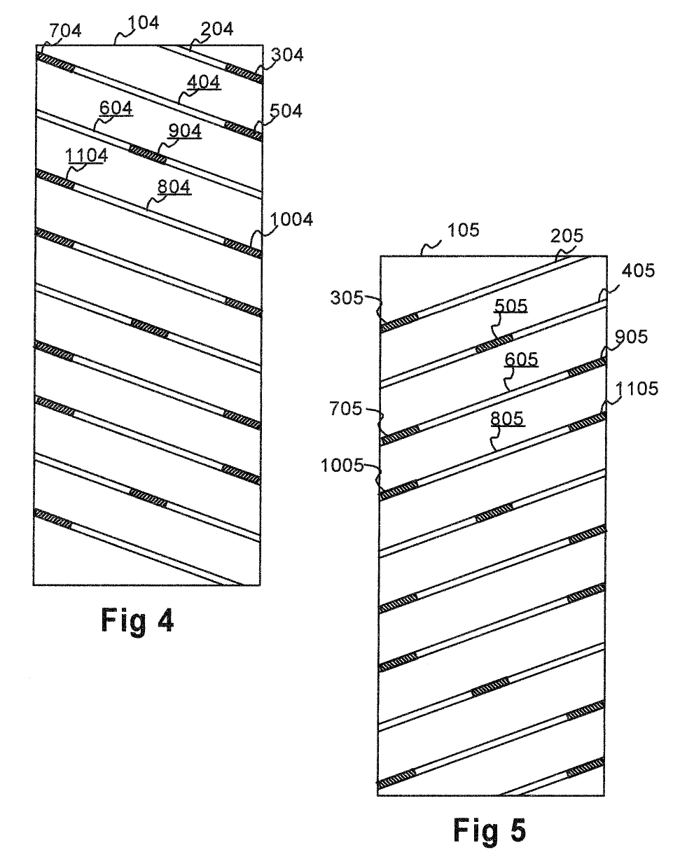

FIGS. 4 and 5 demonstrate the orientation of the grooves and the placement of the slave magnets. The rectangles 104 and 105 represent the surfaces of the slave wheels as if they were laid out flat. The grooves in slave wheel 104 slope downwards from left to right at an angle of about 35 degrees from horizontal. The grooves in slave wheel 501 slope upward from left to right at an angle of about 35 degrees from horizontal. In FIG. 4, grooves 204, 404, 604, and 804 are representative of the grooves in one slave wheel. Grooves 205, 405, 605, and 805 of the slave wheel represented in FIG. 5 are representative of grooves in the other slave wheel.

Slave magnets are fitted into the grooves. In FIG. 4, representative slave magnets are 304, 504, 704, 904, 1004, and 1104. The preferred position of the slave magnets is that two adjacent grooves have magnets positioned at their ends as shown with 304, 504, and 704 in grooves 204 and 404. The next groove 604 has a single slave magnet 904 centrally placed. This pattern of two grooves with end magnets and the third with a central magnet is repeated. The preferred embodiment has a total of 9 grooves and 15 slave magnets per slave wheel. FIG. 5 shows that the same pattern is used in the second slave wheel, for instance in the manner in which slave magnets 305, 505, 706, 905, 1005, and 1105 are positioned in grooves 205, 405, 605, and 805.

In the preferred embodiment, the north pole of each slave magnet faces outwardly from the groove; however, the south pole facing out produces equally satisfactory results. The magnets can be glued into place or otherwise firmly fixed so they do not shift. The attractive forces these magnets produce if opposite poles are allowed to make magnetic contact requires approximately 1200 ft. lbs. to overcome. Slave and drive magnets are permanent magnets and have the same pole facing outwards, producing repulsive forces on the order of 38 measured gauss.

The magnetic drive assembly of the cowling embodiment comprises paired clam-shell cowlings 601a, 601b and 501a, 501b, best seen in FIG. 2, which shows the cowlings in an open position, exposing the slave wheels. FIG. 1 shows the cowlings in a closed position, in which the invention operates. Crank handles 1001, 1101 operate worm-drives to provide for opening and closing the cowlings in order to adjust the gap between the cowlings and the slave wheels, and, hence, the gap between the drive magnets and the slave magnets.

FIG. 1 also shows drive magnets 701, 801 placed on the outer surface of cowlings 501a and 601a respectively. A plurality of ferro-magnetic bolts 901 penetrate the clam-shell cowling through threaded holes. These bolts modify the magnetic field and eliminate dead spots. The placing of the drive magnets and bolts is discussed below.

From FIG. 1 it can be seen that the combined curvature of the paired clam-shell cowlings results in them nearly surrounding their respective slave wheel when in the closed position. That is, each member of a cowling pair surrounds somewhat less than 180 degrees of the slave wheel's circumference so that when juxtaposed in the closed position, together they surround nearly 360 degrees of the slave wheel circumference.

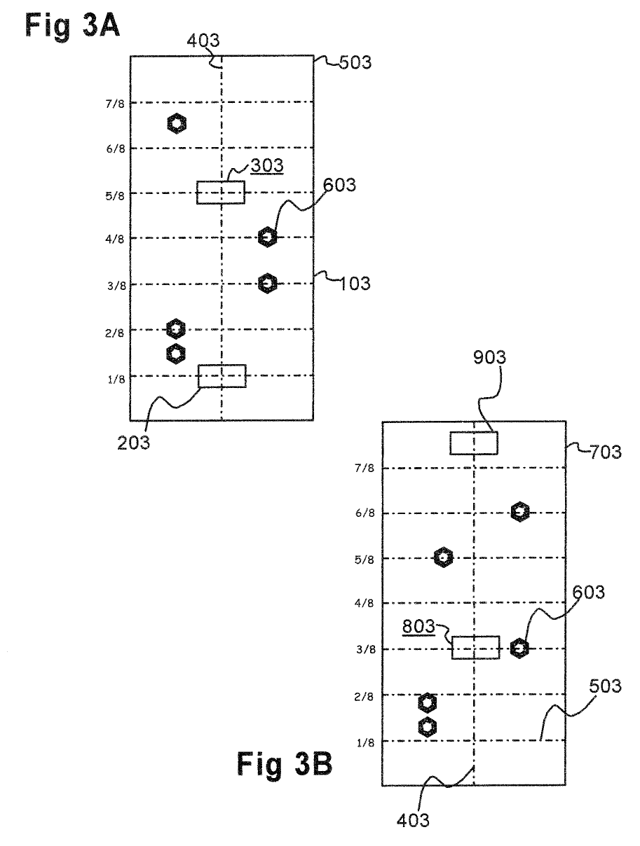

FIGS. 3A and 3B represent a pattern for mounting the slave magnets on the outside, or convex, surface of one pair cowlings. The figure represents the cowling-halves 103, 703 as if they were laid flat. Guide lines are provided in the figure to indicate the longitudinal bisecting lines 403 and horizontal lines 503 dividing each cowling into eighths.

With respect to the cowling-half shown in FIG. 3A, two permanent drive magnets, 203, 303 are glued to the outside surface of the cowling on line 403 bisecting the cowling longitudinally. One drive magnet 203 is placed approximately ⅛ of the way from one end. The second drive magnet 303 is placed ⅜ of the way from the opposite end Ferro-magnetic bolts 603 are inserted in the cowling through threaded holes. The purpose of the bolts is to modify the magnetic field to eliminate dead spots.

With respect to the cowling-half shown in FIG. 3B, drive magnet 803 is placed ⅜ of the way from one end, and drive magnet 903 is placed ⅛ of the way from the other end. Again, ferro-magnetic bolts 603 are provided for eliminating dead spots in the magnetic field.

The diameter across each slave wheel is approximately 10 inches. Measured from the bottom of groove 404 the diameter is 9 inches. Consequently, the arc length from the bottom of one groove to the bottom of an adjacent groove is π inches (i.e., 3.14 inches).

The drive magnets are glued or otherwise firmly fixed to the outer or concave surfaces of the cowlings. Assuming the slave magnets have been mounted in the grooves of the slave wheels with the north pole facing outwards, the north pole of each drive magnet is fixed against the cowling surface so that like-faces-like. As the cowlings are moved toward the slave wheels by turning the cranks 1101, 1001 the drive magnets repel the slave magnets, causing the slave wheels to rotate.

Adjustment of the spacing between the cowlings and the slave wheels by means of cranks 1101, 1001 adjusts the strength of the interaction of the fields of the drive magnets and slave magnets and, hence, the torque on the slave wheels.

As shown in FIG. 1, fly-wheels 301, 401 can optionally be mounted on the slave shaft. The preferred position is at or near the end of the shaft.

Slave shaft 201 thus turns as a result of the magnetic force from the cowlings being applied to the slave wheels. This shaft can be coupled to an output such as the armature of a generator 1301, either directly or through a fly-wheel, as shown. Alternatively, the magnetic motor could itself drive a hydraulic pump of a transmission, thereby reducing the number transmission components and the complexity of transmissions overall. Many different applications for this motor become obvious once it is realized that by using very strong permanent drive magnets useful power can be generated.

It is possible to vary the dimensions of the slave wheels. Presently, the preferred diameter is approximately 10 inches and a width of 5 inches. The motor can operate with the slave shaft 201 vertical or horizontal. While aluminum is a suitable material for the motor, the use of a hard plastic or ceramic materials have also been used with success. Pheotic plastic is presently preferred.

By using two slave wheels rather than just one, any dead spots in one wheel will be compensated for by the other wheel. The upper limit or the number of slave wheels is not yet known. The lower limit is one.

### Drive Wheel Embodiment

The drive wheel embodiment of the invention is a variation of the foregoing cowling embodiment and also comprises a magnetic drive assembly and a magnetic slave assembly. In the drive wheel embodiment, the magnetic slave assembly comprises slave wheels similar to those in the cowling embodiment; that is, having a diameter of approximately 10 inches and made of non-magnetic material such as pheolite plastic. However, the grooved slave wheels of the cowling embodiment may be substituted with slave wheels having notches cut in the edges of the wheel to receive the slave magnets.

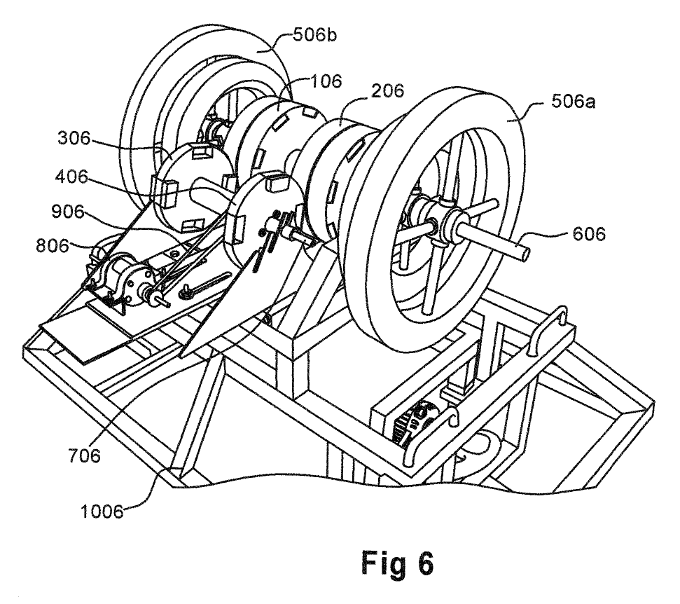

FIG. 6 shows the drive wheel embodiment of the invention. The magnetic drive assembly comprises a pair of rotatable drive wheels 306, 406 bearing drive magnets as described in detail below. The drive wheels are mounted on drive shaft 706. The drive shaft is rotatably mounted on frame 1006 and is coupled to a starter motor 806 by a belt drive 906.

The magnetic slave assembly comprises a pair of magnetic slave wheels 106, 206 mounted on rotatable slave shaft 606. Each slave wheel is associated with a drive wheel. Fly-wheels 506a, 506b are optionally mounted on the slave shaft. The shaft is rotatably mounted on frame 1006.

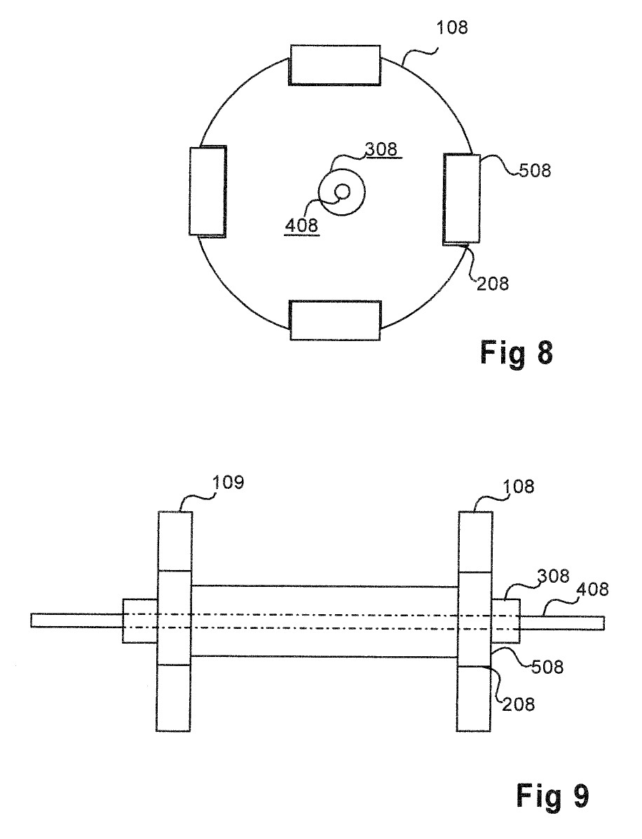

FIGS. 8 and 9 show the details of the drive wheels. FIG. 8 is an end-view of a pair of drive wheels showing one such wheel 108 with four notches 208 for holding the drive magnets 508. The notches are spaced apart at 90 degrees. There is provided a collar 408 for fixing the wheel to the drive shaft 308. The collar may be fitted with set-screws or other means for attaching the wheel to the shaft. FIG. 9 shows the orientation of a first drive wheel 108 and a second drive wheel 109 on the drive shaft 308

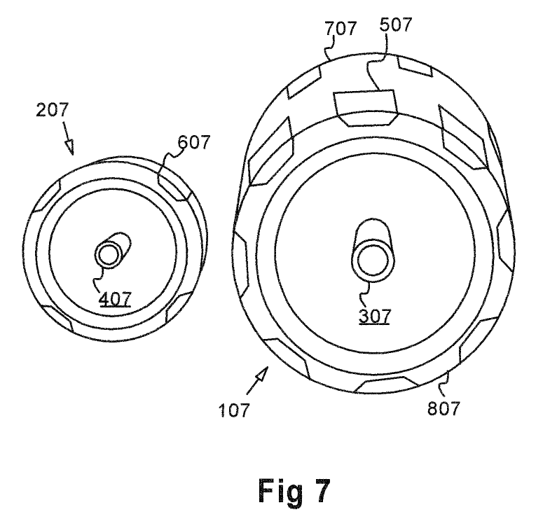

FIG. 7 shows the magnetic drive wheel 207 and its relationship to its respective magnetic slave wheel 107.

The slave wheel has a collar or hub 307 that receives the slave shaft, which rotates on bearings. The collar may be fitted with set screws or the like in order to fix the slave wheel to the slave shaft. Where there are multiple slave wheels they may either be mounted on a common slave shaft or on separate slave shafts.

The circumferential surface of the slave wheel has two edges 707, 807. A plurality of indentations or notches are cut into these edges to receive a plurality of slave magnets, of which 507 is one example. Each notch houses one slave magnet. The slave magnets around a given edge are set 45 degrees apart, giving a total of 8 slave magnets per edge, or 16 per wheel.

As noted previously, the magnetic drive wheel 207 has a hub 407 for receiving the drive shaft.

When the drive wheel and slave wheel are in working position, the slave shaft and the drive shaft are parallel so that the edges of the slave wheel and drive wheel face each other and the plane of each wheel is essentially perpendicular to the axis of its shaft and the drive wheel is substantially centered with its respective slave wheel. However, satisfactory results can be obtained if the plane of the slave wheel is tipped so that the slave wheel is splayed at an angle to the axis of the drive shaft.

Drive magnets 607 are fixed to notches cut in the edge of drive wheel 207. Adjacent drive magnets are set 90 degrees apart, providing 4 drive magnets per drive wheel.

A small electric motor 806 is provided with a drive-belt coupling 906 to the drive shaft.

The magnetic motor is activated by initially turning the drive wheels using electric start-up motor 806. As the drive magnets rotate, their magnetic field entrains the slave wheels and the slave wheels rotate. As the slave wheels rotate they, in turn, produce a reverse entrainment of the drive wheels. When the system reaches speed, only small additional inputs of external energy are required through electric motor 806 in order to maintain the angular momentum of the fly-wheels, even if the slave shaft is coupled to an electric generator.

### SUMMARY

Accordingly while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

I claim:

1. A magnetic motor comprising:
a) a magnetic drive assembly having at least one drive magnet; and,
b) a magnetic slave assembly comprising:
i) at least one rotatable slave shaft;
ii) at least one rotatable slave wheel mounted on said slave shaft; and,
iii) at least one slave magnet mounted on said slave wheel, said slave magnet being magnetically coupled to said drive magnet, wherein the poles of said drive magnet and said slave magnet are oriented in a like-faces-like orientation,
whereby magnetic forces produced between said magnetically coupled drive magnet and slave magnet drive said rotatable slave wheel to rotate, and wherein rotation of said slave wheel causes said slave shaft to rotate.

2. The magnetic motor of claim 1 wherein said magnetic drive assembly comprises a clam-shell cowling adapted to surround a portion of said slave wheel, wherein said clam-shell cowling has a concave surface facing said slave wheel and a convex surface, and wherein said drive magnet is mounted on said clam-shell cowling means.

3. The magnetic motor of claim 2 wherein said drive magnet is mounted on the convex surface of said clam-shell cowling.

4. The magnetic motor of claim 3 further comprising at least one ferro-magnetic bolt penetrating said clam-shell cowling through a threaded hole, the head of said ferro-magnetic bolt being disposed to the outside of said clam-shell cowling.

5. The magnetic motor of claim 2 wherein said slave assembly further comprises an adjustment means for moving said clam-shell cowling means closer to and farther away from said slave wheel, whereby the distance between said drive magnet and said slave magnet is adjusted.

6. The magnetic motor of claim 1 wherein said slave wheel further comprises at least one groove cut into the circumferential surface of said slave wheel, wherein said slave magnet is mounted in said groove.

7. The magnetic motor of claim 1 wherein the number of slave wheels is two.

8. The magnetic motor of claim 1 wherein at least one of said drive magnet and said slave magnet is a permanent magnet.

9. The magnetic motor of claim 1 wherein said magnetic drive means comprises at least one drive wheel wherein said drive wheel has mounted upon it said drive magnet.

10. The magnetic motor of claim 9 wherein the number of said drive magnets mounted on said drive wheel is four.

11. The magnetic motor of claim 10 wherein adjacent ones of said drive magnets are spaced apart at approximately 90 degrees on the circumference of said drive wheel.

12. The magnetic motor of claim 1 wherein said slave magnet is mounted on said slave wheel by means of a notch cut into said slave wheel.

13. The magnetic motor of claim 12 wherein the number of notches and slave magnets on each edge of said slave wheel is eight, and wherein adjacent ones of said notches and magnets are spaced apart by approximately 45 degrees along the circumference of said slave wheel edge.

14. The magnetic motor of claim 1 wherein said slave assembly further comprises at least one fly-wheel mounted on said slave shaft.

15. A magnetic motor, comprising:
(a) a frame;
(b) a shaft coupled to said frame;
(c) a pair of non-magnetic wheels mounted on said shaft, wherein for each wheel one of said shaft and said each wheel is rotatable and said each wheel has a plurality of equally spaced apart grooves running over a cylindrical surface of said wheel from a first side to a second side of said wheel with a radial separation of a start of said groove on said first side to an end of said groove on said second side being approximately 35 degrees and an orientation of said grooves on said pair of wheels being opposite to one another;
(d) a pair of non-magnetic cowlings, each having a semi-circular surface facing said wheel of slightly larger diameter than said wheel;
(e) a pair of spaced apart permanent magnets affixed to an outside surface of each of said pair of cowlings oriented with a north pole of each of said permanent magnets facing a corresponding cowling, said permanent magnets on said front cowling being ⅛^{th} and ⅝^{th} up, respectively, from a bottom thereof and said permanent magnets on said rear cowling being ⅜ths and 15/16^{th} up from a bottom thereof; and
(f) a plurality of permanent magnets placed in said grooves in a pattern with two permanent magnets placed on opposite sides of each of two adjacent grooves and one placed at the center of a third groove adjacent to said two adjacent grooves and placing permanent magnets for subsequent grooves with the same pattern, a north pole of each of said permanent magnets facing outwardly.
